(19) United States
(12) Patent Application Publication
(10) Pub. No.: US 2016/0345018 A1
(43) Pub. Date: Nov. 24, 2016

(54) VIDEO ENCODING AND DECODING

(71) Applicant: Microsoft Technology Licensing, LLC, Redmond, WA (US)

(72) Inventors: Shyam Sadhwani, Bellevue, WA (US); Srinath Reddy, Redmond, WA (US); Yongjun Wu, Bellevue, WA (US); Victor Cherepanov, Redmond, WA (US); Yuechuan Li, Issaquah, WA (US); Chihlung Lin, Redmond, WA (US)

(21) Appl. No.: 14/716,786

(22) Filed: May 19, 2015

(51) Int. Cl. H04N 19/517; H04N 19/136; H04N 19/176

(52) U.S. Cl. CPC H04N 19/517; H04N 19/176; H04N 19/136

(57) ABSTRACT

A video encoding system balances memory usage to store interpolated image data with processing resource usage to interpolate image data without encoding quality degradation or with better encoding quality. This balance can be achieved by identifying and interpolating subregions of a reference image. Each subregion is less than the whole reference image, but larger than a search region for any single block of an image for which motion vectors are to be computed. Each interpolated subregion of the reference image is used to compute motion vectors for multiple blocks of an image being encoded. A video encoding system can identify portions of an image being encoded for which sub-pixel resolution motion vectors are not computed. Motion vectors for such portions of the image can be computed using a reference image without interpolation.

### BACKGROUND

Digital media data, such as audio and video and still images, are commonly encoded into bitstreams that are transmitted or stored in data files, where the encoded bitstreams conform to established standards. An example of such a standard for encoding video is a format called ISO/IEC 23008-2 MPEG-H Part 2, also called and ITU-T H.265, or HEVC or H.265. Herein, a bitstream that is encoded in accordance with this standard is called an HEVC-compliant bitstream.

As part of the process of encoding video, such as to produce an HEVC-compliant bitstream, motion vectors can be computed for an image, also called a frame. In general, the image is divided into blocks, and each block is compared to a reference image. Pixel data from the reference image can be interpolated to provide higher resolution image data, such as in HEVC. For example, for each block of the image to be encoded, image data from a search region of the reference image corresponding to the block can be interpolated. Alternatively, the entire reference image may be interpolated. Motion vectors can be computed for each block of the current image based on the interpolated reference image data for that block. By using the higher resolution image data, higher precision motion vectors, at a sub-pixel resolution, can be computed. Sub-pixel resolution motion vectors provide better motion compensation and thus less residual data to be encoded.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a video encoding system can balance usage of memory to store interpolated image data with usage of processing resources to interpolate image data. This balance can be achieved by identifying and interpolating subregions of a reference image. Each subregion is less than the whole reference image, but larger than a search region for any single block of an image for which motion vectors are to be computed. Each interpolated subregion of the reference image is used to compute motion vectors for multiple blocks of an image being encoded.

In another aspect, the video encoding system can identify portions of an image being encoded for which sub-pixel resolution motion vectors are not computed. Motion vectors for such portions of the image can be computed using a reference image without interpolation. An example of such a portion of an image is a background, which generally has minimal motion from frame to frame in video or uniform global motion from frame to frame.

Similar techniques can be applied in a video decoding system to balance memory and processor usage.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computing device configured to encode video data.

FIG. 2 is a block diagram of an example implementation of a video encoding hardware.

FIG. 3 is a data flow diagram describing an example implementation of video encoding.

FIG. 4 is a flow chart illustrating an example implementation of a process for selecting subregion of a reference frame for interpolation.

FIG. 5 is a graphical illustration of selection of a subregion of a reference frame.

FIG. 6 is a block diagram of an example computing device with which components of a video processing system can be implemented.

### DETAILED DESCRIPTION

The following section provides a description of example implementations for a video processing system. Herein, a video processing system can refer to a video encoding system or a video decoding system or both.

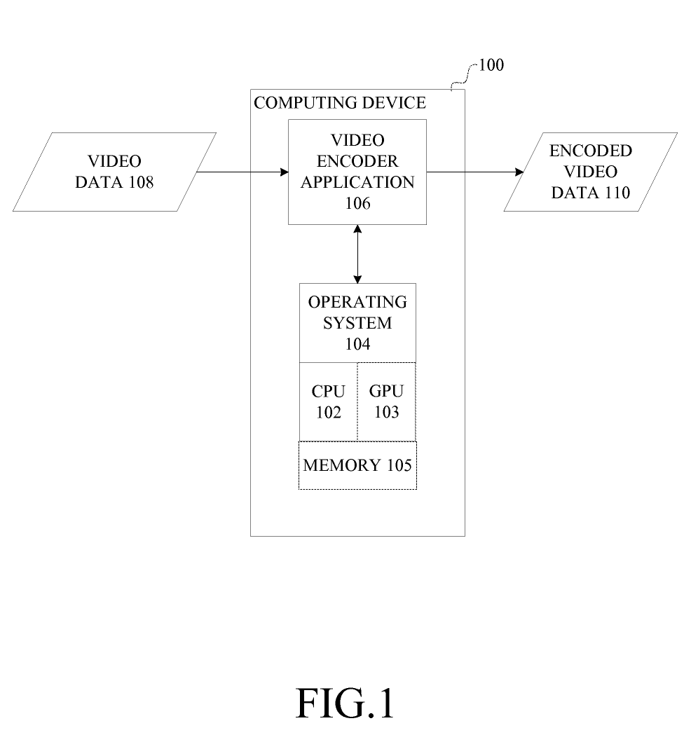

Referring to FIG. 1, an example video encoding system will now be described. A video encoding system can be implemented using a video encoder application 106, which is a computer program executed on a computing device 100. This computer program configures the computing device 100 to perform the functions of, and configure memory and other resources used by, a video encoding system. The computing device 100 generally comprises at least one central processing unit 102, at least one graphics processing unit 103, memory 105 and an operating system 104 utilized by the video encoder application 106.

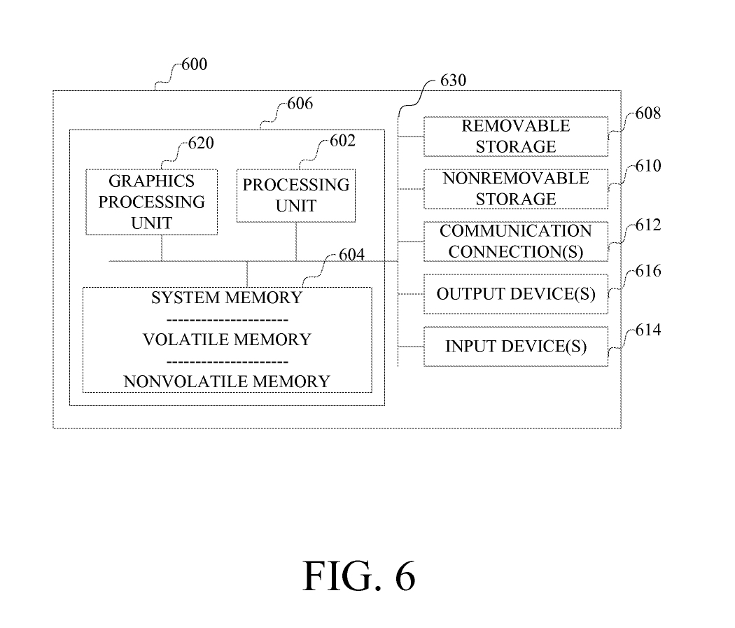

In this example, the video encoder application can be implemented as a computer program that runs on the computing device, while the operating system manages access by that computer program to the resources of the computing device, such as the central processing unit 102, graphics processing unit 103, memory 105 and other components of the computing device, such as storage, input and output devices, and communication interfaces. The video encoder application 106 can utilize the resources of either or both of the central processing unit and graphics processing unit. For example, the video encoder application can include one or more shaders to be executed on the graphics processing unit to perform operations used in the video encoding process. Resources of an example computing device are described in more detail below in connection with FIG. 6.

The video encoder application 106 configures the computing device to read video data 108 and encode the video data into encoded video data 110 that is compliant with a standard data format. The video data 108 is a temporal and spatial sampling of visual information to produce a sequence of image data. The visual information may originate from a camera or other imaging device or other sensor, or may be computer generated. The video data has a temporal resolution, indicating a number of images per unit of time, such as a number of frames or fields per second. The video data also has a spatial resolution, indicating a number of pixels in each of at least two dimensions. Each pixel represents visual information and can be in any of a variety of formats. Such video data 110 generally is provided in a format that conforms to a known standard and with data providing an indication of that format such that the computing device, as configured by a video encoder application 106, can process the video data.

The encoded video data 110 generally is in the form of a bitstream, and can also include other types of data. For the purposes of this description, only encoding of a single stream of video data is described; it should be understood that encoded video data can be combined with other data in an encoded bitstream. An encoded bitstream thus generally represents a combination of encoded digital media data, such as audio, video, still images, text and auxiliary information. If multiple streams of a variety of types of data to be encoded, such as audio and video, the encoded bitstreams for the different types of data can be multiplexed into a single bitstream. Encoded bitstreams generally either are transmitted, in which case the may be referred to as streamed data, or are stored in data files on a storage medium, or can be stored in data structures in memory. Encoded bitstreams, and files or data structures they are stored in, generally conform to established standards. For example, the video encoder application 106 can be used to implement a video encoding system that is HEVC-compliant.

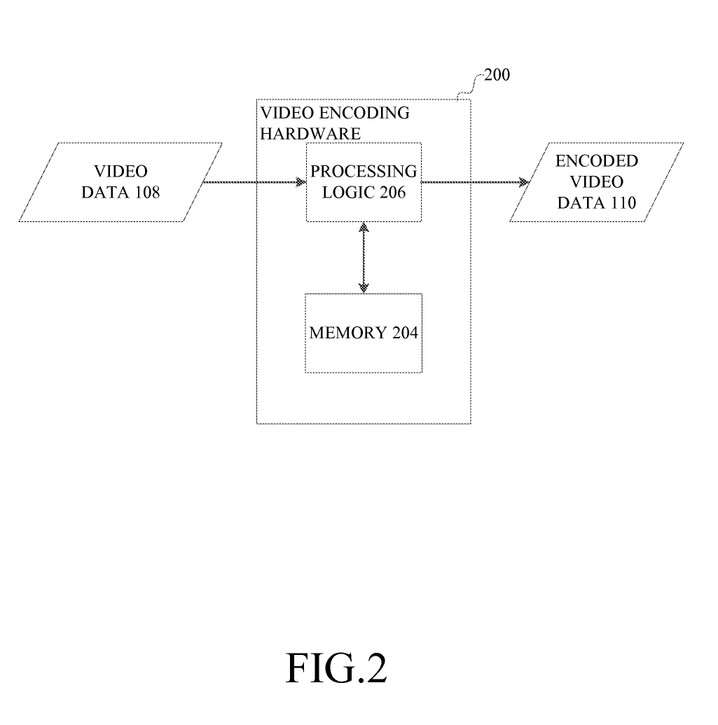

In an implementation shown in FIG. 2, a video encoding system can be implemented using video encoding hardware 200 that receives video data 108 at an input, and outputs encoded video data 110 at an output. The inputs and outputs of such video encoding hardware 200 generally are implemented in the form of one or more buffer memories (not shown). The video encoding hardware comprises processing logic 206 and memory 204. The processing logic 206 can be implemented using a number of types of logic device or combination of logic devices, including but not limited to, programmable digital signal processing circuits, programmable gate arrays, including but not limited to field-programmable gate arrays (FPGA's), application-specific integrated circuits (ASICs), application-specific standard products (ASSPs), systems-on-a-chip systems (SOCs), complex programmable logic devices (CPLDs), or a dedicated, programmed microprocessor. Such processing logic 206 accesses memory 204 which comprises one or more memory devices which store data used by the processing logic when encoding the video data 108, including but not limited to the video data 108, parameters used by the encoding process, intermediate data computed for the encoding process, and the encoded video data.

Such video encoding hardware 200 may reside in a computing device 100, and can be one of the resources used by a video encoder application 106. For example, such encoding hardware 200 may be present as a coprocessor in a computing device. Such video encoding hardware also can reside in other devices independently of a general purpose computing device.

Generally speaking, to encode video data, a video encoding system reads the video data and applies various operations to the video data based on the encoding standard. For each image of video data to be encoded, there may be one or more intermediate images or other data produced by different stages of the encoding process. Such data is stored in memory accessed by the video encoding system, such as in memory 105 (FIG. 1) or memory 204 (FIG. 2).

As a particular example, many standard video encoding techniques use a technique called motion compensation, which involves computing motion vectors between visual information in one image and related visual information in temporally proximate images in the video data. Each encoding standard generally defines how such motion vectors are to be computed, encoded and then decoded. Generally speaking, an image is divided into blocks, and motion vectors are computed for each block by searching for similar visual information in blocks of another image called a reference image. Each block in an image to be encoded using motion compensation has an associated search region in the reference image. Blocks typically are 8 pixels by 8 pixels or 16 pixels by 16 pixels, but can be any number of pixels in each of the horizontal and vertical dimensions of an image.

In some standards, such as HEVC, pixels of image data in the reference image are interpolated when computing motion vectors. Such interpolation provides higher resolution image data, from which higher precision motion vectors can be computed. The motion vectors then are computed using the interpolated image data. Other video encoding processes also can take advantage of such interpolated image data. The use of interpolated image data to compute motion vectors is often referred to as sub-pel interpolation or sub-pixel interpolation, which in turn provides sub-pel or sub-pixel motion vectors.

To perform such interpolation, a video encoding system, as described herein, can balance usage of memory for storing interpolated image data with usage of processing resources to interpolate image data. This balance can be achieved by identifying and interpolating subregions of a reference image. Each subregion is less than the whole reference image, but larger than a search region for any single block of an image for which motion vectors are to be computed. Each interpolated subregion of the reference image is used to compute motion vectors for multiple blocks of an image being encoded.

To perform such interpolation, a video encoding system, as described herein, can identify portions of an image being encoded for which sub-pixel resolution motion vectors are not computed. The video encoding system can compute motion vectors for such portions of the image using the reference image without interpolation. An example of a portion of an image for which sub-pixel interpolation can be omitted is any portion which generally has minimal motion, or global uniform motion, from frame to frame in the video, such as a background portion or a portion with a large object.

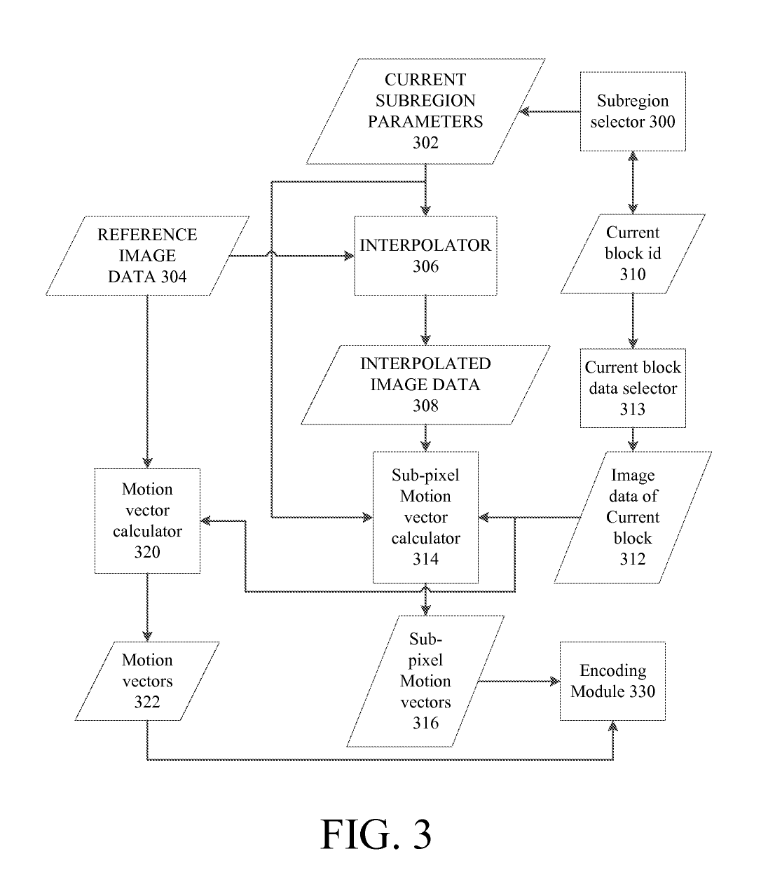

Referring now to FIG. 3, a data flow diagram illustrates an example implementation of a portion of a video encoding system, which can be implemented using, for example, a programmable processing system configured by computer program instructions, or one or more logic devices, and memory, such as in FIG. 1 or FIG. 2. The portion of the video encoding system shown in FIG. 3 is intended to illustrate the selection of subregions for interpolation and calculation of motion vectors; a video encoding system includes other components which are not shown in FIG. 3 but which implement other operations of the video encoding process.

The video encoding system can include, in relevant part, a subregion selector 300. The subregion selector 300, given an identifier of a current block 310 of an image to be encoded, specifies parameters 302 for a subregion of the reference image data 304 to be used for computing motion vectors for the current block. The subregion selector can provide the current block identifier to other parts of the video encoder, or can receive the current block identifier as an input, such as from a controller (not shown), depending on the implementation.

An interpolator 306 generates interpolated image data 308 for the specified subregion of the reference image data 304. The reference image data 304 and interpolated image data 308 are stored in memory. Image data 312 corresponding to the current block identifier 310, accessed from memory by a current block data selector 313, and the interpolated image data 308, are inputs to a sub-pixel motion vector calculator 314. The sub-pixel motion vector calculator 314 computes one or more sub-pixel motion vectors 316 for the current block 310 from the image data 312 and interpolated image data 308. The sub-pixel motion vectors 316 are output to an encoding module 330, which is illustrative of the rest of the video encoding system, which processes the current image data and motion vectors into the final encoded form.

How the subregion selector 300 determines the size of the subregion of the reference image to be used for a set of blocks of a current image can vary based on available processing and memory resources.

In one implementation, a subregion is a set of blocks in the reference image that encompasses the search regions for two or more blocks of an image to be encoded, but is substantially less than the size of the reference image. The subregion is thus an N block by M block subregion of the reference image. The values of N and M can be positive integers, with at least one of them being greater than one, and can be equal. A search region, for a single block can be, for example, a 3 block by 3 block region of the reference image. In this implementation, the interpolated image data for a subregion specified as a set of two or more blocks is computed for the first block of the set, stored in memory, and then used for the remaining blocks in that set of blocks. Interpolated image data for a subregion to be used for a block is computed if the search region for computing motion vectors for that block might access an area of the reference image which is not located in subregion for which interpolated image data is currently calculated and stored.

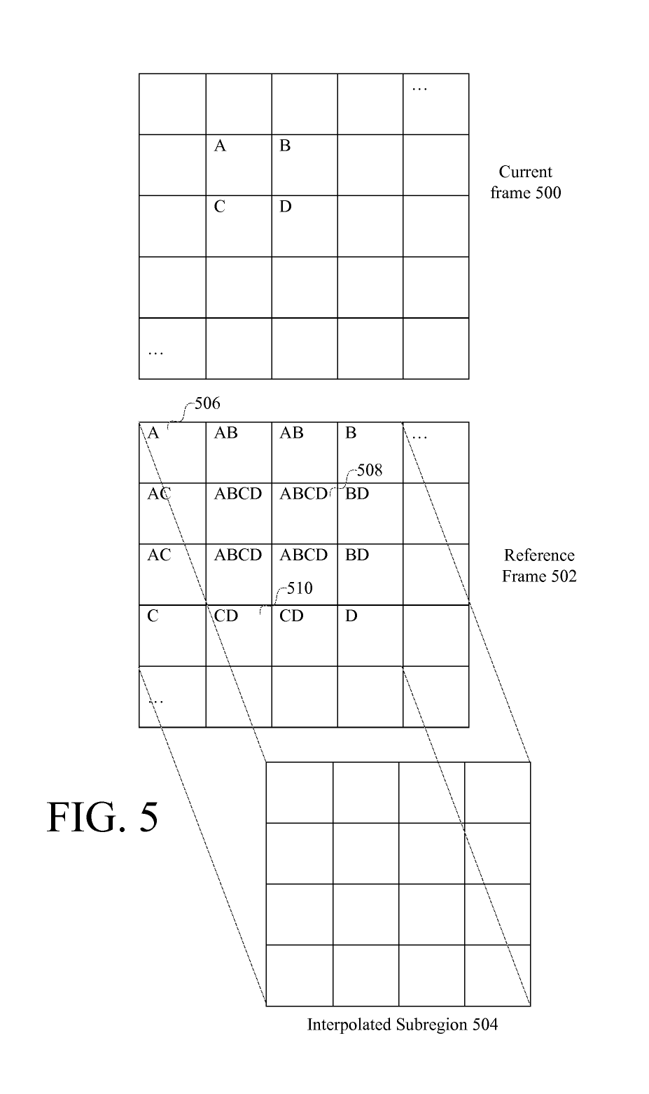

In one implementation, the set of blocks for an image are collected into groups of N×N blocks, such as a group of 2 blocks by 2 blocks in the image, or 3 blocks by 3 blocks, or 4 blocks by 4 blocks. In one implementation, the search regions that would otherwise be used for each of the blocks in a collection of blocks are aggregated to form the subregion to be interpolated for the blocks in that group. For example, given a group of 2 blocks by 2 blocks (i.e., four blocks), each with a 3 block by 3 block search region in the reference image, the aggregated search region is a four block by four block search region in the reference image. Generally speaking, in one implementation, each set of blocks in the current image comprises an N block by P block set of blocks in the current image. In such a case, the subregion selector defines, for each set of blocks, an N plus M blocks by P plus M block region in the reference image as a subregion for the set of blocks, wherein N and P are positive integers, with at least one of N and P being greater than the smallest coding block size in the video coding standard, typically one (1), and M is a positive integer which can be based the size of the search region for a block. In the example implementation used below in connection with FIG. 5, N is 2, P is 2 and M is 2. In one implementation, the subregion can be defined by an additional amount larger than search regions for the collection of blocks.

In any of the foregoing example implementations, the size of each subregion can be dependent on statistics of images, and regions or blocks of those images, that have already been processed. For example, if the magnitudes of the motion vectors for some regions of an image are small, then the subregions of the reference frame that are selected for those regions can be small. Similarly, if the magnitudes of the motion vectors for some regions of an image are large, then the interpolated subregions of the reference frame which are computed for those regions of the image can be large. Any other comparison of previously processed images to currently processed images to determine estimates of motion in different regions of the current image can be used to determine different subregion sizes to interpolate for those regions.

In another example implementation, blocks of the reference frame that form the subregion used for interpolation can be interpolated and stored in a cache. As a new block uses a search region in the reference frame which is not encompassed by any currently cached interpolated blocks of the reference frame, additional interpolated data can be computed and added to a cache. Any interpolated block that has not been used can be discarded to maintain the cache at less than a predetermined size.

In another example implementation, one or more blocks of an image to be encoded can be identified for encoding without using sub-pixel resolution motion vectors. In such an implementation, sub-pixel resolution motion vectors are not computed for these blocks. Motion vectors for such portions of the image can be computed using a reference image without interpolation. An example of such a portion of an image in video is an area which generally has minimal motion, or uniform global motion, from frame to frame in the video, such as a background or a large object.

Such portions can be detected in several ways. For example, statistics derived from a set of encoded images can be computed, such as the average magnitudes of motion vectors for each block in a sequence. If the average magnitude of motion vectors for a certain block is small, then such a block can be marked as a block for which sub-pixel interpolation is not performed. Any other comparison of previously processed images to currently processed images, to determine similarity of blocks in different images in the sequence, can be used to determine whether to interpolate the search region from the reference image for those blocks.

In response to a determination that one or more blocks do not use sub-pixel interpolation, the subregion selector 300 can provide an indication of this determination to the interpolator 306 and sub-pixel motion vector calculator 314, shown in FIG. 3 as part of the subregion parameters 302. These components thus do not compute sub-pixel motion vectors for these one or more blocks. Instead, the reference image data 304 and image data 312 for the current block can be provided to a motion vector calculator 320, which computes motion vectors 322 without sub-pixel interpolation. The computed motion vectors 322 are provided to the encoding module 330.

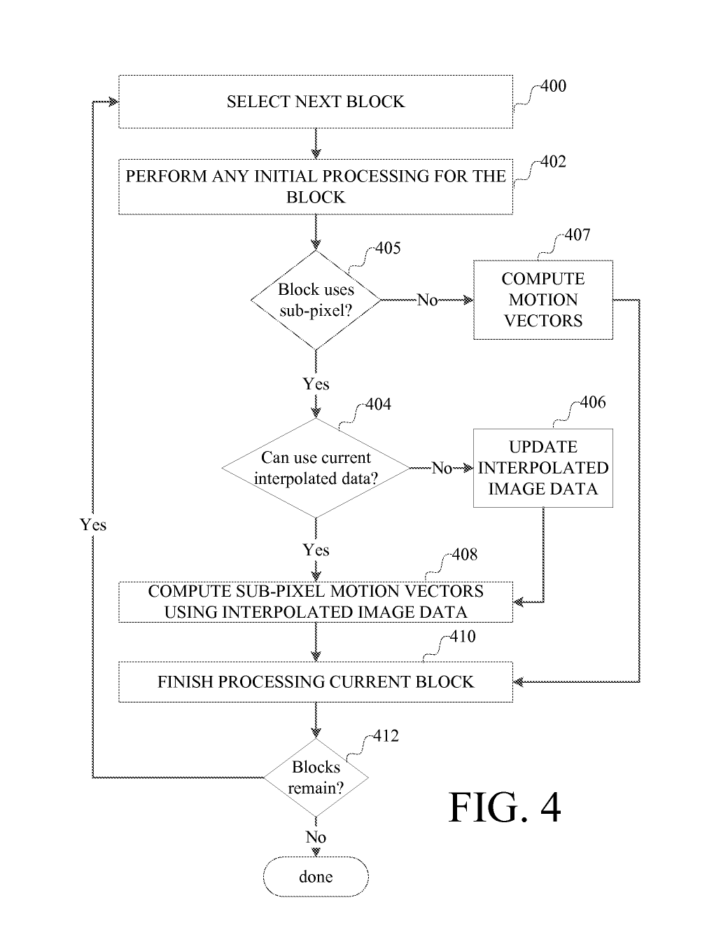

A flowchart in FIG. 4, and corresponding graphical illustration in FIG. 5, describe one these example implementations in more detail.

In FIG. 5, a current frame for which motion vectors are to be computed is partially shown at 500. The current frame includes at least blocks A, B, C and D. The selection and labeling of blocks in FIG. 5 is solely for the purposes of illustration. In this example, it is assumed that the motion vectors will be computed with respect to a reference frame 502. Given a block, e.g., block A, in the current frame 500, a search area is defined in the reference frame 502. In the example shown in FIG. 5, for illustrative purposes only, the search area includes a center block in a position in the reference frame corresponding to the position of the given block in the current frame, and an area of one block in each direction surrounding that center block. Thus, in 502, the search area for each of blocks A, B, C and D are shown by placing the labels, A, B, C and D respectively in each block of the reference frame which are part of the search area for that block. Thus, block 506 is in the search region for block A, block 508 is in the search regions for blocks A, B, C and D, and block 510 is in the search regions for blocks C and D.

Given the search areas of blocks A, B, C and D, a subregion of the reference frame to be used for interpolation can be defined, as illustrated at 504. In this illustrative example, the subregion is defined by the union of the four search areas A, B, C and D. In this example, the resulting subregion 504 is a 4 block by 4 block subregion of the reference frame 502. The union of these search areas can be extended by a number of blocks to provide a larger subregion if desired. The image data for these blocks of the reference frame, i.e., this subregion 504, can be interpolated to provide the interpolated image data for the subregion. In one implementation, statistics for this group of blocks can be computed to determine whether sub-pixel interpolation will be used for this group of blocks.

Turning now to FIG. 4, an example process of computing motion vectors for each block will now be described in more detail. Much of the encoding process is defined by a given standard (or non-standardized) compression algorithm. For example, the particular order in which blocks are selected, the reference frame to which they are compared, the search region size and location in the reference frame, the matching operation and the formula for computing a motion vector, can vary by implementation and is different from standard to standard. Given the selection (400) of a current block, the identification and interpolation of the subregion of the reference frame to be used for computing the motion vectors will be described in more detail in FIG. 4.

As shown in FIG. 4, the video encoding system selects (400) a current block. The video encoding system performs (402) any initial processing of the block data for the current block, in accordance with the encoding process being used. In one implementation, the video encoding system determines whether the current interpolated subregion of the reference frame includes the search region of the current block, as shown at 404. In response to a determination that the current subregion does not include the search region of the current block, the video encoding system updates (406) the subregion. The video encoding system updates this subregion using one of the techniques described above for determining the subregion of the reference frame to use for a group of block of an image given a selected block of that image, and then interpolates image data of that subregion of the reference frame and stores the interpolated image data in memory.

Given an interpolated image data for the subregion for the current block, the video encoding system computes (408) the sub-pixel motion vectors using the interpolate image data for the subregion, to provide motion vectors with sub-pixel resolution. The video encoding system then performs 410 any final processing for the block. If more blocks remain to be processed, as indicated at 412, the video encoding system repeats the process with the next block.

The process illustrated by FIG. 4 can also include steps to determine whether to compute sub-pixel motion vectors. For example, this determination can be made as indicated at step 405 in a manner as described above. If the video encoding system determines that sub-pixel motion vectors are not being calculated for a block, then it can calculate 507 motion vectors using the image data of the current block and the search region for the block in the reference image.

In the foregoing example, given the initial subregion as defined at 504 in FIG. 5, one will note that blocks A-D can be processed using the same interpolated image data for that subregion. However, any next block to be processed after these blocks results in the search region for that next block not being found in the subregion for which interpolated image data is currently available in memory. Thus, the next subregion is then defined, and its interpolated image data is calculated and loaded into memory.

Using this process thus eliminates calculating the interpolated reference image for each block, thus reducing processing resource usage. Additionally, the entire reference image is not interpolated, thus reducing memory usage. The size of the interpolated subregion can be selected based on a specified or available memory size for storing the interpolated data.

The foregoing examples are intended to illustrate, not limit, techniques used to identify and interpolate subregions of a reference image for computing motion vectors. By identifying such subregions, a balance between processing and memory resource usage can be achieved.

Such techniques are particularly useful for any video application on a computing device with limited resources, such as limited processing capability, limited memory, and limited power sources, particularly battery power. A particular example of such an application is a videoconferencing application, particularly where one of the devices is a mobile device, handheld device, or other small computing device which has limited processing and memory resources and battery power. Videoconferencing and other applications typically provide video data in which portions, such as a background, do not have significant motion from frame to frame. By computing a subregion of a reference frame once for the purposes of computing the motion vectors for each block in such portions of the video, processing time and memory consumption can be significantly reduced.

A video decoding system also can be implemented using similar techniques to specify interpolated subregions of reference images that are used in combination with motion vectors for multiple blocks of an image to be decoded. Instead of computing an entire interpolated reference image, or computing only a single interpolated block for a selected motion vector, subregions of the reference image can be interpolated for multiple motion vectors for multiple blocks. Such a video decoding system can be implemented a video decoder application implemented as a computer program that runs on a computing device. Such a video decoder application can utilize the resources of either or both of the central processing unit and graphics processing unit. For example, the video decoder application can include one or more shaders to be executed on the graphics processing unit to perform operations used in the video decoding process. The video decoding system can be implemented using video decoding hardware comprising processing logic and memory. Such video decoding hardware may reside in a computing device and can be one of the resources used by a video decoder application. Such video decoding hardware also can reside in other devices independently of a general purpose computing device. In decoding, sub-pixel motion vectors are used in combination with interpolated image data as part of the decoding process to compute decoded video data.

Having now described an example implementation, FIG. 6 illustrates an example of a computing device in which such techniques can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 6, an example computer 600 includes at least one processing unit 602 and memory 604. The computer can have multiple processing units 602. A processing unit 602 can include one or more processing cores (not shown) that operate independently of each other. Additional coprocessing units, such as graphics processing unit 620, also can be present in the computer. The memory 604 may be volatile (such as dynamic random access memory (DRAM) or other random access memory device), non-volatile (such as a read-only memory, flash memory, and the like) or some combination of the two. The computer 600 may include additional storage (removable and/or non-removable) including, but not limited to, magnetically-recorded or optically-recorded disks or tape. Such additional storage is illustrated in FIG. 6 by removable storage 608 and non-removable storage 610. The various components in FIG. 6 are generally interconnected by an interconnection mechanism, such as one or more buses 630.

A computer storage medium is any medium in which data can be stored in and retrieved from addressable physical storage locations by the computer. Computer storage media includes volatile and nonvolatile memory, and removable and non-removable storage media. Memory 604 and 606, removable storage 608 and non-removable storage 610 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. The computer storage media can include combinations of multiple storage devices, such as a storage array, which can be managed by an operating system or file system to appear to the computer as one or more volumes of storage. Computer storage media and communication media are mutually exclusive categories of media.

Computer 600 may also include communications connection(s) 612 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, radio frequency, infrared and other wireless media. Communications connections 612 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media, and may perform various functions with respect to that data.

Computer 600 may have various input device(s) 614 such as a keyboard, mouse, pen, camera, touch input device, sensor (e.g., accelerometer or gyroscope), and so on. Output device(s) 616 such as a display, speakers, a printer, and so on may also be included. All of these devices are well known in the art and need not be discussed at length here. The input and output devices can be part of a housing that contains the various components of the computer in FIG. 6, or can be separable from that housing and connected to the computer through various connection interfaces, such as a serial bus, wireless communication connection and the like. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, hover, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (such as electroencephalogram techniques and related methods).

The various storage 610, communication connections 612, output devices 616 and input devices 614 can be integrated within a housing with the rest of the computer, or can be connected through input/output interface devices on the computer, in which case the reference numbers 610, 612, 614 and 616 can indicate either the interface for connection to a device or the device itself as the case may be.

A computer generally includes an operating system, which is a computer program running on the computer that manages access to the various resources of the computer by applications. There may be multiple applications. The various resources include the memory, storage, input devices and output devices, such as display devices and input devices as shown in FIG. 6. A file system generally is implemented as part of an operating system of the computer, but can be distinct from the operating system. The file system may be practiced in distributed computing environments where operations are performed by multiple computers that are linked through a communications network. In a distributed computing environment, computer programs may be located in both local and remote computer storage media and can be executed by processing units of different computers

The operating system, file system and applications can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Accordingly, in one aspect a video processing system includes memory configured to store reference image data defining a reference image and current image data defining a current image to be processed. A subregion selector comprises an output configured to provide, for each set of blocks of the current image, data defining a subregion selected from among a plurality of subregions of the reference image as a search region for the set of blocks. An interpolator comprises a first input configured to receive the data defining the subregion from the subregion selector, a second input configured to receive the reference image data from the memory for the subregion of the reference image, and an output configured to provide interpolated image data for the subregion. The memory is further configured to store the interpolated image data. A sub-pixel motion vector calculator comprises a first input configured to receive current image data for a block of the current image, a second input configured to receive the interpolated image data for the subregion of the reference image for the block, and an output configured to provide sub-pixel resolution motion vectors for the block.

In another aspect, a video processing system comprises a means for selecting subregions of a reference image. The means for selecting can provide, for each set of blocks of the current image, data defining a subregion selected from among a plurality of subregions of the reference image as a search region for the set of blocks. The video processing system further comprises means for interpolating image data from the plurality of subregions of the reference image. The video processing system further comprises a means for performing sub-pixel motion vector calculation between image data for a current image and the interpolated image data for the subregions of the reference image.

Another aspect is a process for processing video data performed by a processing system comprising at least one processing unit and memory. The process comprises accessing, in the memory, reference image data for a reference image and current image data for a current image to be processed, the current image data comprising blocks of image data. The process further comprises computing, and storing in the memory, interpolated image data for a subregion of the reference image corresponding to a search region for a plurality of the blocks of the current image data. The process further comprises selecting a block of the current image. The process further comprises determining whether the selected block has a search region encompassed by the subregion having interpolated image data in the memory, and, in response to a determination that the search region of the selected block is not encompassed by the subregion, updating the interpolated image data in the memory to include interpolated image data for the search region for the selected block and at least one additional block of the current image. The process further comprises computing sub-pixel motion vectors for the selected block of the current image using the interpolated image data in the memory corresponding to the selected block. The process further comprises repeating the selecting, determining, updating and computing for the blocks of the current image.

In another aspect, subregion selection can involve identifying one or more blocks of the current image to be encoded without using sub-pixel resolution motion vectors.

In any of the foregoing aspects, each set of blocks can comprise an N block by P block set of blocks in the current image and the subregion selector is configured to define, for each set of blocks, an N plus M by P plus M set of blocks in the reference image as a subregion for the set of blocks, wherein N and P are positive integers, and at least one of N and P are greater than the smallest coding block size in the video coding standard, and M is a positive integer.

In any of the foregoing aspects, the subregion of the reference image can be a set of blocks in the reference image that encompasses search regions for two or more blocks of the current image, and a size in pixels of the subregion of the reference image is substantially less than a size in pixels of the reference image.

In any of the foregoing aspects, at least one subregion can be smaller in size than the reference image, but larger in size than any search region for any single block of the current image.

In any of the foregoing aspects, the interpolated image data for the subregion can include blocks of the reference image as interpolated and stored in a cache.

In any of the foregoing aspects, as each block of the current image is processed, the interpolated image data for the subregion stored in memory can be used for the block in response to a determination that a search region for the block is encompassed in the subregion, and, interpolated image data for another subregion can be computed and stored in the memory in response to a determination that the search region for the block includes an area of the reference image not located in the subregion having interpolated image data stored in the memory.

In any of the foregoing aspects, subregion selection can involve identifying one or more blocks of the current image to be encoded without using sub-pixel resolution motion vectors.

In any of the foregoing aspects, the video processing system can include video encoding hardware.

In any of the foregoing aspects, the video processing system can include a computing device configured by a video encoding application.

In any of the foregoing aspects, a processing system can include at least one processing unit and the memory, the processing system being configured by the video encoder application to implement the subregion selector, the interpolator, and the sub-pixel motion vector calculator.

In another aspect, a video processing system comprises means for decoding video data using, for sets of blocks of an image, data defining a subregion selected from among a plurality of subregions of a reference image as a search region for the set of blocks.

Any of the foregoing aspects may be embodied in one or more computers, as any individual component of such a computer, as a process performed by one or more computers or any individual component of such a computer, or as an article of manufacture including computer storage with computer program instructions are stored and which, when processed by one or more computers, configure the one or more computers.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A video processing system comprising:
memory configured to store reference image data defining a reference image and current image data defining a current image to be processed;
a subregion selector having an output configured to provide, for each set of blocks of the current image, data defining a subregion selected from among a plurality of subregions of the reference image as a search region for the set of blocks;
an interpolator having a first input configured to receive the data defining the subregion from the subregion selector, a second input configured to receive the reference image data from the memory for the subregion of the reference image, and an output configured to provide interpolated image data for the subregion, the memory being further configured to store the interpolated image data; and
a sub-pixel motion vector calculator having a first input configured to receive current image data for a block of the current image, a second input configured to receive the interpolated image data for the subregion of the reference image for the block, and an output configured to provide sub-pixel resolution motion vectors for the block.

2. The video processing system of claim 1, wherein each set of blocks comprises an N block by P block set of blocks in the current image and the subregion selector is configured to define, for each set of blocks, an N plus M by P plus M set of blocks in the reference image as a subregion for the set of blocks, wherein N and P are positive integers, and at least one of N and P are greater than the smallest coding block size in the video coding standard, and M is a positive integer.

3. The video processing system of claim 1, wherein the subregion of the reference image is a set of blocks in the reference image that encompasses search regions for two or more blocks of the current image, and a size in pixels of the subregion of the reference image is substantially less than a size in pixels of the reference image.

4. The video processing system of claim 1, wherein at least one subregion is smaller in size than the reference image, but larger in size than any search region for any single block of the current image.

5. The video processing system of claim 1, wherein the interpolated image data for the subregion comprises blocks of the reference image as interpolated and stored in a cache.

6. The video processing system of claim 1, wherein, as each block of the current image is processed, the interpolated image data for the subregion stored in memory is used for the block in response to a determination that a search region for the block is encompassed in the subregion, and, interpolated image data for another subregion is computed and stored in the memory in response to a determination that the search region for the block includes an area of the reference image not located in the subregion having interpolated image data stored in the memory.

7. The video processing system of claim 1, wherein the subregion selector is further configured to identify one or more blocks of the current image to be encoded without using sub-pixel resolution motion vectors.

8. The video processing system of claim 1, comprising a video encoder application executing on a processing system.

9. The video processing system of claim 9, wherein the processing system comprises at least one processing unit and the memory, the processing system being configured by the video encoder application to implement the subregion selector, the interpolator, and the sub-pixel motion vector calculator.

10. The video processing system of claim 1, further comprising one or more logic devices implementing the subregion selector, the interpolator, and the sub-pixel motion vector calculator.

12. A process for processing video data performed by a processing system comprising at least one processing unit and memory, the process comprising:
accessing, in the memory, reference image data for a reference image and current image data for a current image to be processed, the current image data comprising blocks of image data;
computing, and storing in the memory, interpolated image data for a subregion of the reference image corresponding to a search region for a plurality of the blocks of the current image data;
selecting a block of the current image;
determining whether the selected block has a search region encompassed by the subregion having interpolated image data in the memory, and, in response to a determination that the search region of the selected block is not encompassed by the subregion, updating the interpolated image data in the memory to include interpolated image data for the search region for the selected block and at least one additional block of the current image;
computing sub-pixel motion vectors for the selected block of the current image using the interpolated image data in the memory corresponding to the selected block;
repeating the selecting, determining, updating and computing for the blocks of the current image.

12. The process of claim 11, wherein each set of blocks comprises an N block by P block set of blocks in the current image and a subregion comprises, for each set of blocks, an N plus M by P plus M set of blocks in the reference image, wherein N and P are positive integers, and at least one of N and P are greater than the smallest coding block size in the video coding standard, and M is a positive integer.

13. The process of claim 11, wherein the subregion of the reference image is a set of blocks in the reference image that encompasses search regions for two or more blocks of the current image, and has a size in pixels of the subregion substantially less than a size in pixels of the reference image.

14. The process of claim 11, wherein at least one subregion is smaller in size than the reference image, but larger in size than any search region for any single block of the current image.

15. The process of claim 11, further comprising identifying one or more blocks of the current image to be encoded without using sub-pixel resolution motion vectors.

16. A computer program product comprising:
a computer readable storage medium;
computer program instructions stored on the computer readable storage medium that, when processed by a processing system comprising at least one processing unit and memory, configures the processing system to:
access, in the memory, reference image data for a reference image and current image data for a current image to be processed, the current image data comprising blocks of image data;
compute, and store in memory, interpolated image data for a subregion of the reference image corresponding to a search region for a plurality of blocks of the current image data;
select a block of the current image;
determine whether the selected block has a search region encompassed by the subregion having interpolated image data in the memory, and, in response to a determination that the search region of the selected block is not encompassed by the subregion, update the interpolated image data in the memory to include interpolated image data for the search region for the selected block and at least one additional block of the current image;
compute sub-pixel motion vectors for the selected block of the current image using the interpolated image data in the memory corresponding to the selected block;
repeat the selecting, determining, updating and computing for the blocks of the current image.

17. The computer program product of claim 16, wherein each set of blocks comprises an N block by P block set of blocks in the current image and a subregion comprises, for each set of blocks, an N plus M by P plus M set of blocks in the reference image, wherein N and P are positive integers, and at least one of N and P are greater than the smallest coding block size in the video coding standard, and M is a positive integer.

18. The computer program product of claim 16, wherein the subregion of the reference image is a set of blocks in the reference image that encompasses search regions for two or more blocks of the current image, and has a size in pixels substantially less than a size in pixels of the reference image.

19. The computer program product of claim 16, wherein at least one subregion is smaller in size than the reference image, but larger in size than any search region for any single block of the current image.

20. The computer program product of claim 16, wherein the processing system is further configured to identify one or more blocks of the current image to be encoded without using sub-pixel resolution motion vectors.
